(19) United States
(12) Patent Application Publication
(10) Pub. No.: US 2026/0002462 A1
(43) Pub. Date: Jan. 1, 2026

(54) DEGRADATION DEGREE ESTIMATION SYSTEM

(71) Applicant: TOYOTA JIDOSHA KABUSHIKI KAISHA, Toyota-shi (JP)

(72) Inventor: Masato IKEMOTO, Sunto-gun, Shizuoka-ken (JP)

(73) Assignee: TOYOTA JIDOSHA KABUSHIKI KAISHA, Toyota-shi (JP)

(21) Appl. No.: 19/039,968

(22) Filed: Jan. 29, 2025

(30) Foreign Application Priority Data
Jun. 26, 2024 (JP) 2024-103217

(51) Int. Cl. F01N 11/00; F01N 3/10; G01K 3/00; G01M 15/05

(52) U.S. Cl. CPC F01N 11/007; F01N 3/101; G01K 3/005; G01M 15/05; F01N 2550/02

(57) ABSTRACT

A degradation degree estimation system includes: an airflow meter; a three-way catalyst; an air-fuel ratio sensor; an NOx sensor; and an estimation device that estimates a degree of degradation of the three-way catalyst. The estimation device includes: an acquisition unit that acquires a detected rich air-fuel ratio that is a detected air-fuel ratio detected by the air-fuel ratio sensor when the detected air-fuel ratio indicates a rich air-fuel ratio, a detected intake air amount detected by the airflow meter, and a detected ammonia amount detected by the NOx sensor; and an estimation unit that estimates the degree of degradation based on the detected rich air-fuel ratio, the detected intake air amount, and the detected ammonia amount, the estimation unit estimating a higher degree of degradation as the detected ammonia amount is smaller with respect to the detected rich air-fuel ratio and the detected intake air amount.

### CROSS-REFERENCE TO RELATED APPLICATION

This application claims priority to Japanese Patent Application No. 2024-103217 filed on Jun. 26, 2024. The disclosure of the above-identified application, including the specification, drawings, and claims, is incorporated by reference herein in its entirety.

### BACKGROUND

### 1. Technical Field

The present disclosure relates to a degradation degree estimation system.

### 2. Description of Related Art

There is a technique of calculating a maximum oxygen storage amount of a three-way catalyst and estimating a degree of degradation of the three-way catalyst based on the maximum oxygen storage amount (see Japanese Unexamined Patent Application Publication No. 2012-241652 (JP 2012-241652 A), for example).

### SUMMARY

In order to calculate the maximum oxygen storage amount, it is necessary to change the three-way catalyst from an oxygen-depleted state to an oxygen-saturated state. When the three-way catalyst is in the oxygen-saturated state, the emission of NOx may be increased.

Thus, it is an object to provide a degradation degree estimation system able to estimate a degree of degradation of a three-way catalyst while suppressing the emission of NOx.

The above object can be achieved by a degradation degree estimation system including:
an airflow meter that detects an intake air amount of an engine;
a three-way catalyst disposed in an exhaust passage of the engine and able to store oxygen;
an air-fuel ratio sensor disposed in the exhaust passage upstream of the three-way catalyst;
an NOx sensor disposed in the exhaust passage downstream of the three-way catalyst and able to detect an amount of ammonia in an exhaust gas; and an estimation device that estimates a degree of degradation of the three-way catalyst, in which
the estimation device includes an acquisition unit that acquires a detected rich air-fuel ratio that is a detected air-fuel ratio detected by the air-fuel ratio sensor when the detected air-fuel ratio indicates a rich air-fuel ratio, a detected intake air amount detected by the airflow meter, and a detected ammonia amount detected by the NOx sensor, and
an estimation unit that estimates the degree of degradation based on the detected rich air-fuel ratio, the detected intake air amount, and the detected ammonia amount, the estimation unit estimating a higher degree of degradation as the detected ammonia amount is smaller with respect to the detected rich air-fuel ratio and the detected intake air amount.

The acquisition unit may acquire at least three detected rich air-fuel ratios having different values, and the detected intake air amount and the detected ammonia amount corresponding to each of the at least three detected rich air-fuel ratios; and the estimation unit may estimate the degree of degradation based on the at least three detected rich air-fuel ratios and the detected intake air amount and the detected ammonia amount corresponding to the each of the at least three detected rich air-fuel ratios.

An upstream catalyst able to store oxygen and a downstream catalyst located downstream of the upstream catalyst may be disposed in the exhaust passage; the three-way catalyst may be the downstream catalyst;
the air-fuel ratio sensor may be disposed between the upstream catalyst and the downstream catalyst; and
the estimation device may include
a control unit that executes a rich active process of reciprocating the detected air-fuel ratio at least three times between a stoichiometric air-fuel ratio and a rich air-fuel ratio by switching a target air-fuel ratio of the engine from a rich air-fuel ratio to a lean air-fuel ratio when the detected air-fuel ratio becomes equal to or less than a determination value indicating a rich air-fuel ratio, and switching the target air-fuel ratio from a lean air-fuel ratio to a rich air-fuel ratio when the detected air-fuel ratio becomes equal to or more than the stoichiometric air-fuel ratio, and
a switching unit that switches the determination value to a different value when the detected air-fuel ratio becomes equal to or less than the determination value during execution of the rich active process.

The acquisition unit may acquire, as the detected rich air-fuel ratio, a minimum value of the detected air-fuel ratio during a period since the detected air-fuel ratio becomes equal to or less than the determination value until the detected air-fuel ratio becomes equal to or more than the stoichiometric air-fuel ratio, and acquire, as the detected ammonia amount, a maximum value of the ammonia amount during the period since the detected air-fuel ratio becomes equal to or less than the determination value until the detected air-fuel ratio becomes equal to or more than the stoichiometric air-fuel ratio.

The estimation device may include an upstream catalyst estimation unit that estimates a degree of degradation of the upstream catalyst based on a maximum oxygen storage amount of the upstream catalyst;
the upstream catalyst estimation unit may estimate the degree of degradation of the upstream catalyst when a temperature of the downstream catalyst is higher than a predetermined temperature; and
the estimation unit may estimate a degree of degradation of the downstream catalyst when the temperature of the downstream catalyst is equal to or lower than the predetermined temperature.

It is possible to provide a degradation degree estimation system able to estimate a degree of degradation of a three-way catalyst while suppressing the emission of NOx.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a degradation degree estimation system;

FIG. 2A is a flow chart illustrating the degradation degree estimation control;

FIG. 2B is a map that specifies the relation between the detection-rich air-fuel ratio according to the detected intake air amount and the detected ammonia amount and the degree of degradation of the downstream-catalyst;

FIG. 3 is a timing chart illustrating degradation degree estimation control;

FIG. 4 is a flowchart of a modification of the degradation degree estimation control;

FIG. 5 is a flow chart illustrating a rich active process; and

FIG. 6 is a timing chart of a modification of the degradation degree estimation control.

### DETAILED DESCRIPTION OF EMBODIMENTS

### Schematic Configuration of the Degradation Degree Estimation System

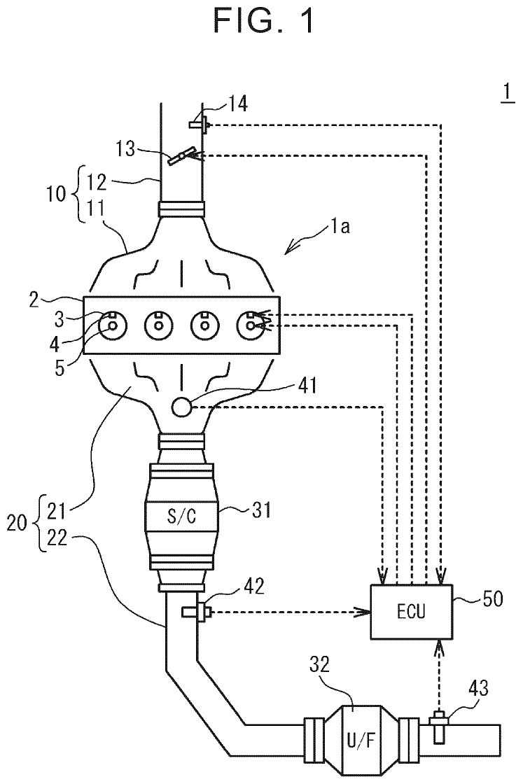

FIG. 1 is a schematic configuration diagram of a degradation degree estimation system 1. The degradation degree estimation system 1 is mounted on, for example, a vehicle, but is not limited thereto, and may be mounted on a ship or the like other than the vehicle. The degradation degree estimation system 1 includes an engine 1a and an ECU (Electric Control Unit) 50. The engine 1a includes an engine body 2, an intake passage 10, and an exhaust passage 20. The engine body 2 includes a plurality of cylinders 3. The cylinder 3 is provided with an in-cylinder injection valve 4 and an ignition plug 5. In addition to the in-cylinder injection valve 4 or in addition to the in-cylinder injection valve 4, a port injection valve may be provided.

The intake passage 10 includes an intake manifold 11 connected to the engine body 2 and an intake pipe 12 upstream of the intake manifold 11. The intake pipe 12 is provided with a throttle valve 13 for adjusting an intake air amount. The intake pipe 12 is provided with an airflow meter 14 upstream of the throttle valve 13. The airflow meter 14 detects an amount of intake air.

The exhaust passage 20 includes an exhaust manifold 21 connected to the engine body 2 and an exhaust pipe 22 downstream of the exhaust manifold 21. An upstream catalyst 31 is disposed between the exhaust manifold 21 and the exhaust pipe 22. A downstream catalyst 32 is disposed in the exhaust pipe 22. An upstream air-fuel ratio sensor 41 is provided at a junction of a branch portion connected to each cylinder of the exhaust manifold 21. A downstream air-fuel ratio sensor 42 is provided in the exhaust pipe 22 downstream of the upstream catalyst 31. A NOx sensor 43 is provided in the exhaust pipe 22 downstream of the downstream catalyst 32. The upstream air-fuel ratio sensor 41 detects the air-fuel ratio of the exhaust gas flowing into the upstream catalyst 31. The downstream air-fuel ratio sensor 42 detects the air-fuel ratio of the exhaust gas discharged from the upstream catalyst 31 and flowing into the downstream catalyst 32. The output of NOx sensor 43 correlates with the amount of NOx in the exhaust gas in a lean atmosphere, and correlates with the amount of ammonia in the exhaust gas in a rich atmosphere. Therefore, the output of NOx sensor 43 when the exhaust gas having the rich air-fuel ratio smaller than the stoichiometric air-fuel ratio flows into the downstream catalyst 32 is correlated with the ammonia amount discharged from the downstream catalyst 32.

The upstream catalyst 31 and the downstream catalyst 32 are three-way catalysts containing catalyst metals such as platinum (Pt), palladium (Pd), and rhodium (Rh) and having an oxygen-storage capacity. The three-way catalyst has a catalytic function and an oxygen storage capacity, and thus has a NOx and HC purifying function according to the oxygen storage capacity. When the air-fuel ratio of the exhaust gas flowing into the three-way catalyst is a lean air-fuel ratio larger than the stoichiometric air-fuel ratio, oxygen in the exhaust gas is stored by the three-way catalyst when the oxygen storage amount of the three-way catalyst is small. Accordingly, NOx in the exhausted gas is reduced and purified. As the amount of oxygen stored in the three-way catalyst increases, the concentration of oxygen and NOx in the exhaust gas flowing out of the three-way catalyst increases. When the air-fuel ratio of the exhaust gas flowing into the three-way catalyst is a rich air-fuel ratio, the oxygen stored in the three-way catalyst is released when the oxygen storage amount in the three-way catalyst is large, and HC in the exhaust gas is oxidized and purified. When the oxygen storage amount in the three-way catalyst decreases, HC in the exhaust gas flowing out of the three-way catalyst increases, and ammonia is generated from NOx in the three-way catalyst.

The ammonia produced by the three-way catalyst is produced by the following reaction in a rich atmosphere.

N₂+3H₂→2NH₃+Thermal reaction

Therefore, the lower the temperature of the three-way catalyst, the more the heat dissipation of the reaction heat is promoted, and the amount of ammonia produced increases. Further, as the pressure of the exhaust gas flowing into the three-way catalyst increases, the reaction proceeds in a direction in which the total number of molecules decreases, and thus the amount of ammonia produced increases.

ECU 50 includes storage devices such as CPU (Central Processing Unit), RAM (Random Access Memory), ROM (Read Only Memory), and flash memories, and performs various kinds of control by executing programs stored in ROM and storage devices. ECU 50 controls the intake air amount, the fuel-injection amount, the ignition timing, and the like on the basis of the operation amount of the accelerator pedal or the brake pedal operated by the driver, the rotational speed of the engine 1a, the load, and the like. The detected air-fuel ratio detected by the upstream air-fuel ratio sensor 41 and the downstream air-fuel ratio sensor 42 and the output of NOx sensor 43 are inputted to ECU 50. ECU 50 is an exemplary estimation device that estimates the degree of degradation of the downstream-catalyst 32, which will be described in detail later. ECU 50 functionally realizes an acquisition unit and an estimation unit, which will be described later in detail.

ECU 50 controls the engine 1a so that the air-fuel ratio of the exhaust gas discharged from the engine 1a becomes the target air-fuel ratio. Specifically, ECU 50 controls the air-fuel ratio of the exhaust gas discharged from the engine 1a by mainly feedback-controlling the fuel injection amount so that the detected air-fuel ratio of the upstream air-fuel ratio sensor 41 becomes the target air-fuel ratio.

### Degradation Estimation Control

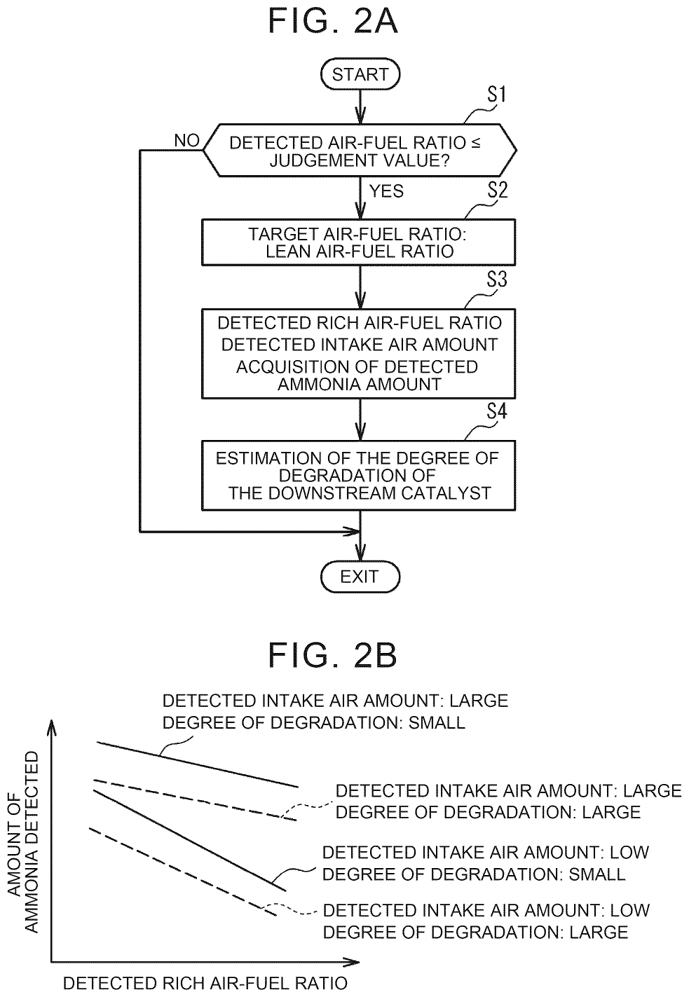

The degradation degree estimation control executed by ECU 50 will be described. FIG. 2A is a flow chart exemplifying the degradation degree estimation control. In the following description, the term “detected air-fuel ratio” means the detected air-fuel ratio of the downstream air-fuel ratio sensor 42. ECU 50 determines whether or not the detected air-fuel ratio is equal to or less than the determination value (S1). The determination value is a value indicating a rich air-fuel ratio. Specifically, when the target air-fuel ratio of the engine 1a is a rich air-fuel ratio and the upstream catalyst 31 is oxygen-depleted, the detected air-fuel ratio of the downstream air-fuel ratio sensor 42 becomes a rich air-fuel ratio equal to or lower than the determination value. If S1 is No, this control ends.

When S1 is Yes, ECU 50 switches the target air-fuel ratio of the engine 1a to the lean air-fuel ratio (S2). Even if the target air-fuel ratio is switched to the lean air-fuel ratio, the exhaust gas having the rich air-fuel ratio flows into and is discharged from the downstream catalyst 32 until a predetermined time elapses. ECU 50 acquires a detected rich air-fuel ratio, which is an air-fuel ratio of the exhaust gas of the rich air-fuel ratio flowing into the downstream-catalyst 32 and is a detection air-fuel ratio, a detection intake air amount detected by the airflow meter 14, and a detected ammonia amount detected by NOx sensor 43 (S3). S3 is an exemplary process executed by the acquisition unit.

Next, ECU 50 estimates the degree of degradation of the downstream-catalyst 32 based on the detected rich air-fuel ratio, the detected intake air amount, and the detected ammonia amount obtained by referring to the map of FIG. 2B (S4). FIG. 2B is a map that defines the relation between the detected rich air-fuel ratio, the detected ammonia amount, and the degree of degradation of the downstream-catalyst 32 in accordance with the detected intake air amount. The larger the detected rich air-fuel ratio, the closer the detected rich air-fuel ratio is to the stoichiometric air-fuel ratio. The smaller the detected rich air-fuel ratio, the greater the degree of richness of the detected rich air-fuel ratio. The smaller the detected rich air-fuel ratio and the larger the detected intake air amount, the greater the detected ammonia amount. According to the map of FIG. 2B, it is estimated that the lower the detected ammonia amount is with respect to the detection-rich air-fuel ratio and the detected intake air amount, the higher the degree of degradation of the downstream catalyst 32 is. The degree of degradation of the downstream catalyst 32 may be estimated by an arithmetic expression using, for example, a detected rich air-fuel ratio, a detection intake air amount, and a detected ammonia amount as arguments. S4 is an exemplary process executed by the estimation unit.

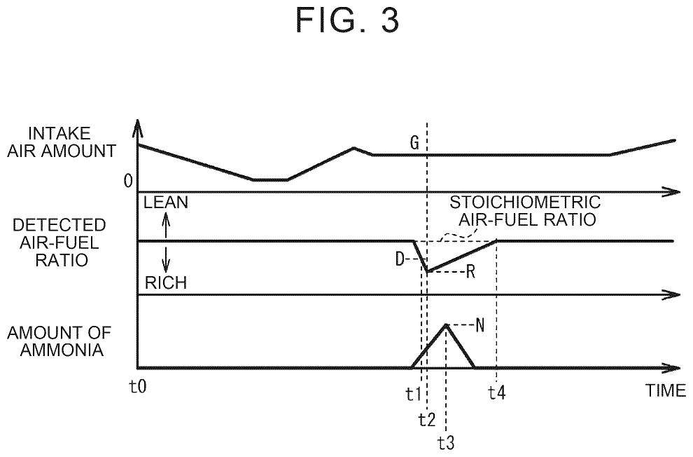

FIG. 3 is a timing chart illustrating degradation degree estimation control. FIG. 3 shows changes in the amount of intake air, the detected air-fuel ratio of the downstream air-fuel ratio sensor 42, and the amount of ammonia in the exhaust gas discharged from the downstream catalyst 32. For example, ECU 50 controls the intake air amount and the target air-fuel ratio according to the operating condition of the engine 1a, and the detected air-fuel ratio is maintained at the stoichiometric air-fuel ratio (time t0). When the upstream catalyst 31 is in the oxygen-depleted state, the detected air-fuel ratio decreases. When the detected air-fuel ratio becomes equal to or less than the determination value D, the target air-fuel ratio is switched to the lean air-fuel ratio (time t1). After the detected air-fuel ratio becomes equal to or less than the determination value D, the detected air-fuel ratio starts to increase after a predetermined time lag (time t2). When the detected air-fuel ratio is switched from decreasing to increasing, the detected air-fuel ratio becomes a minimum value. ECU 50 acquires the smallest value as the above-described detected rich air-fuel ratio R, and acquires the intake air amount when the detected air-fuel ratio becomes the detected rich air-fuel ratio R as the detected intake air amount G. After that, the exhaust gas of the detection-rich air-fuel ratio R passes through the downstream-catalyst 32, and the ammonia-content is maximized (time t3). ECU 50 obtains the largest value as the detected ammonia amount N. Thereafter, the detected air-fuel ratio becomes the stoichiometric air-fuel ratio (time t4).

As described above, ECU 50 estimates the degree of degradation of the downstream-catalyst 32 based on the detection-rich air-fuel ratio R, the detected intake air amount G, and the detected ammonia amount N. For this reason, for example, since the downstream catalyst 32 does not need to be oxygen-saturated, the degree of degradation of the downstream catalyst 32 is estimated while suppressing the emission of NOx.

The detected rich air-fuel ratio R is the minimum value of the detected air-fuel ratio between the time when the detected air-fuel ratio becomes equal to or lower than the determination value D and the time when the detected air-fuel ratio becomes the stoichiometric air-fuel ratio. The detected ammonia amount N is the maximum value of the ammonia amount between the time when the detected air-fuel ratio becomes equal to or lower than the determination value D and the time when the detected air-fuel ratio becomes equal to or lower than the stoichiometric air-fuel ratio again. Therefore, the detected rich air-fuel ratio R and the detected ammonia amount N correspond to each other with high accuracy, and the estimation accuracy of the degradation degree of the downstream catalyst 32 is improved.

ECU 50 acquires, as the detected intake air amount G, the intake air amount when the detected air-fuel ratio becomes the detected rich air-fuel ratio R, but is not limited thereto. There is a predetermined time lag until the intake air whose intake air amount has been detected by the airflow meter 14 is discharged from the engine body 2 and flows into the downstream catalyst 32 as exhaust gas. Accordingly, ECU 50 may acquire, as the detected intake air amount, the intake air amount detected by the airflow meter 14 in advance by the time lag described above from the timing at which the detected air-fuel ratio becomes the detected rich air-fuel ratio R. In this case, the time lag may be calculated according to an operating state such as an intake air amount or an engine speed. Further, the above-described degradation degree estimation control may be executed for a configuration in which the upstream catalyst 31 is not provided.

### Modification of the Degradation Degree Estimation Control

Next, a modification of the degradation degree estimation control executed by ECU 50 will be described. In this variant, ECU 50 functionally realizes the acquisition unit, estimation unit, control unit, switching unit, and upstream catalyst estimation unit, which are described in detail below.

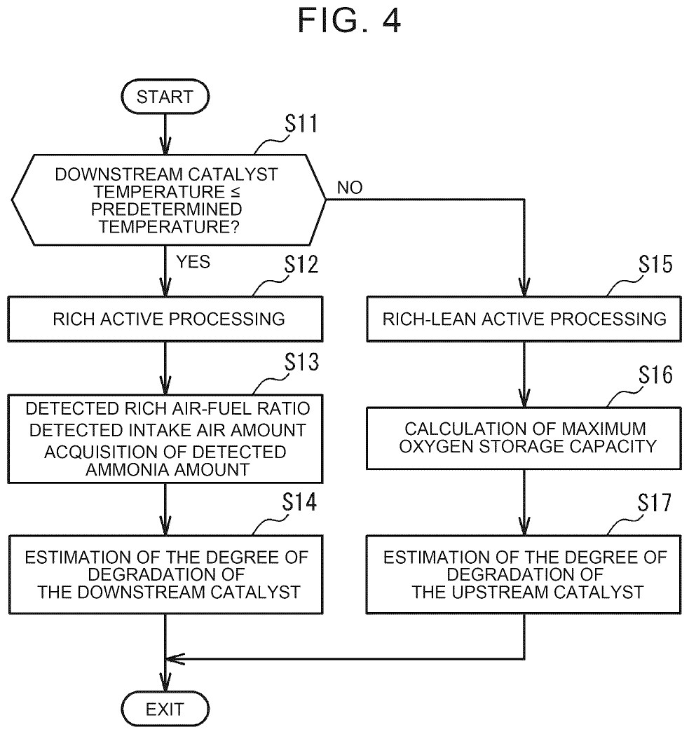

FIG. 4 is a flowchart of a modification of the degradation degree estimation control. ECU 50 determines whether or not the temperature of the downstream-catalyst 32 is equal to or lower than a predetermined temperature (S11). The predetermined temperature is, for example, an upper limit value of the temperature of the downstream catalyst 32 in a case where the amount of ammonia generated by the downstream catalyst 32 in a case where the exhaust gas having the rich air-fuel ratio flows into the downstream catalyst 32 is a generation amount in which the estimation accuracy of the degree of degradation of the downstream catalyst 32 is ensured. As described above, the amount of ammonia produced in the downstream catalyst 32 increases as the temperature of the downstream catalyst 32 decreases. For example, the lower the intake air amount, the lower the temperature of the downstream catalyst 32 may be estimated. Further, the heat transfer amount to the downstream catalyst 32 may be estimated in consideration of the heat transfer amount from the engine body 2 to the exhaust port and the exhaust passage 20 and the upstream catalyst 31, and the temperature of the downstream catalyst 32 may be estimated on the basis of the heat transfer amount to the downstream catalyst 32. Further, a temperature sensor may be provided in the downstream catalyst 32 to acquire the temperature of the downstream catalyst 32. In addition, the temperature of the downstream catalyst 32 may be obtained, estimated, or calculated by a known method.

When S11 is Yes, ECU 50 executes a rich active process to be described later (S12). S12 is an exemplary process executed by the control unit. Next, ECU 50 obtains the detected rich air-fuel ratio, the detection intake air amount, and the detected ammonia amount during the execution of the rich active process (S13), and estimates the degree of degradation of the downstream-catalyst 32 (S14). S13 is an exemplary process executed by the acquisition unit. S14 is an exemplary process executed by the estimation unit.

If S11 is No, ECU 50 performs a rich-lean active process (S15), which will be described later. Next, ECU 50 calculates the maximum oxygen storage amount of the upstream catalyst 31 during the execution of the rich-lean active process (S16), and estimates the degree of degradation of the upstream catalyst 31 based on the maximum oxygen storage amount (S17). S17 is an exemplary process executed by the upstream catalytic estimation unit.

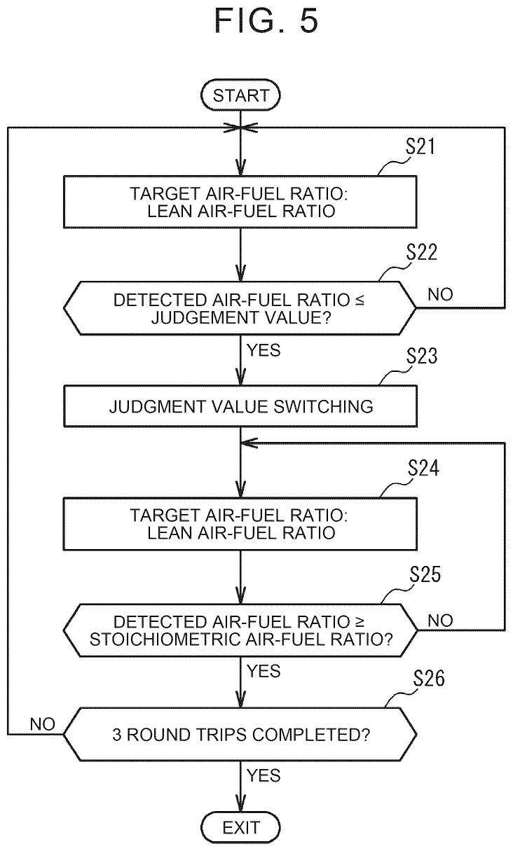

FIG. 5 is a flowchart illustrating rich active processing. ECU 50 switches the target air-fuel ratio to the rich air-fuel ratio (S21). ECU 50 determines whether or not the detected air-fuel ratio is equal to or less than the determination value (S22). If S22 is No, S21 is executed again. When S22 is Yes, ECU 50 switches the determination value to a different value (S23), which will be described in detail later. Next, ECU 50 switches the target air-fuel ratio to the lean air-fuel ratio (S24). ECU 50 determines whether or not the detected air-fuel ratio is equal to or higher than the stoichiometric air-fuel ratio (S25). If S25 is No, S24 is executed again.

If Yes in S25, ECU 50 determines whether or not the number of round trips between the stoichiometric air-fuel ratio of the detected air-fuel ratio and the determined value during the rich active process has been completed three times (S26). For example, ECU 50 may count the number of times the target air-fuel ratio is switched from the rich air-fuel ratio to the lean air-fuel ratio as the number of round trips during the execution of the rich active process. ECU 50 may count the number of times of switching the determination value during the execution of the rich active process as the number of round trips. ECU 50 may count the number of times that the detected air-fuel ratio falls below the determination value as the number of round trips during the execution of the rich active process. ECU 50 may count the number of times that the detected air-fuel ratio becomes lower than the stoichiometric air-fuel ratio to be equal to or higher than the stoichiometric air-fuel ratio as the number of round trips during the execution of the rich active process. If S26 is No, S21 is executed again. If S26 is Yes, the rich active process ends. Therefore, the determination value is switched to a different value three times during execution of the rich active process.

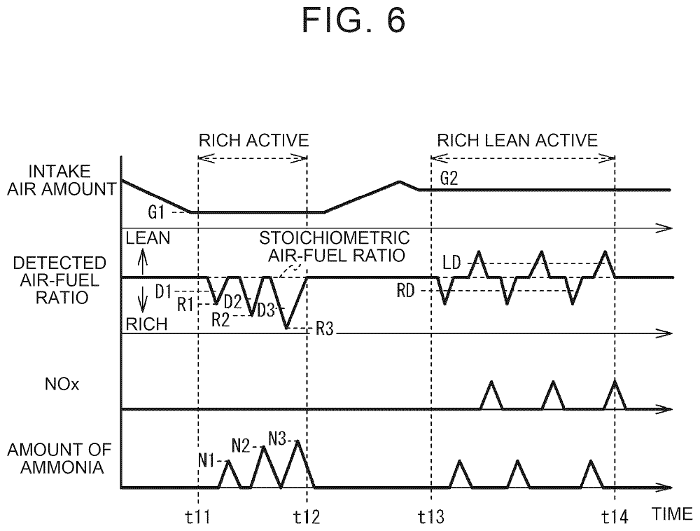

FIG. 6 is a timing chart of a modification of the degradation degree estimation control. FIG. 6 shows changes in the intake air amount, the detected air-fuel ratio of the downstream air-fuel ratio sensor 42, the amount of ammonia in the exhaust gas discharged from the downstream catalyst 32, the amount of ammonia discharged from the upstream catalyst 31, and the amount of NOx. In the example of FIG. 6, the rich-lean active process is executed first, and then the rich-lean active process is executed. In the rich active process, the amount of ammonia in the exhaust gas discharged from the downstream catalyst 32 is indicated. In the rich-lean active process, the amount of ammonia and the amount of NOx in the exhaust gas discharged from the upstream catalyst 31 are shown.

As described above, when the temperature of the downstream-catalyst 32 is equal to or lower than the predetermined temperature, the rich-active process is executed (time t11). When the rich active process is executed, the target air-fuel ratio is switched to the rich air-fuel ratio, and the upstream catalyst 31 is in the oxygen-depleted state, so that the detected air-fuel ratio is lowered. When the detected air-fuel ratio becomes equal to or lower than the determination value D1, the target air-fuel ratio is switched to the lean air-fuel ratio, the detected air-fuel ratio increases, and the detected rich air-fuel ratio R1 and the detected ammonia-amount N1 are acquired. When the detected air-fuel ratio becomes equal to or higher than the stoichiometric air-fuel ratio, the target air-fuel ratio is switched to the rich air-fuel ratio, and the detected air-fuel ratio decreases. When the detected air-fuel ratio becomes equal to or less than the determination value D2 switched from the determination value D1, the target air-fuel ratio is switched to the lean air-fuel ratio, and the detected air-fuel ratio increases, and the detected rich air-fuel ratio R2 and the detected ammonia-amount N2 are acquired. When the detected air-fuel ratio becomes equal to or higher than the stoichiometric air-fuel ratio, the target air-fuel ratio is switched to the rich air-fuel ratio, and the detected air-fuel ratio decreases. When the detected air-fuel ratio becomes equal to or less than the determination value D3 switched from the determination value D2, the target air-fuel ratio is switched to the lean air-fuel ratio, and the detected air-fuel ratio increases, and the detected rich air-fuel ratio R3 and the detected ammonia-amount N3 are acquired. When the detected air-fuel ratio is equal to or higher than the stoichiometric air-fuel ratio, the rich active process ends (time t12).

FIG. 6 illustrates an example in which the detected intake air amount G1 is constant during the execution of the rich active process, the determination value D1 of the determination value D1 to D3 is the maximum, and the determination value D3 is the minimum. Therefore, the detection-rich air-fuel ratio R1 among the detection-rich air-fuel ratio R1 to R3 is the maximum, and the detection-rich air-fuel ratio R3 is the minimum. Among the detected ammonia amount N1 to N3, the detected ammonia amount N3 is the largest and the detected ammonia amount N1 is the smallest. Note that the switching order of the determination values is not limited to the order in which the determination values gradually decrease as illustrated in FIG. 6.

ECU 50 estimates the degree of degradation of the downstream-catalyst 32 based on the detected rich air-fuel ratio R1 to R3, the detected ammonia amount N1 to N3, and the detected intake air amount G1, which are acquired three times. For example, ECU 50 may refer to the map of FIG. 2B and estimate the mean value of the degree of degradation estimated based on each of the detected rich air-fuel ratio R1, the detected ammonia amount N1, and the detected intake air amount G1, the detected rich air-fuel ratio R2, the detected ammonia amount N2, and the detected intake air amount G1, the detected rich air-fuel ratio R3, the detected ammonia amount N3, and the detected intake air amount G1 as the final degree of degradation of the downstream catalyst 32. ECU 50 may estimate the degree of degradation of the downstream-catalyst 32 based on the average value of the detection-rich air-fuel ratio R1 to R3, the average value of the detected ammonia amount N1 to N3, and the detected intake air amount G1. ECU 50 may refer to the map of FIG. 2B to calculate a regression line by a least squares method from the detected rich air-fuel ratio R1, the detected ammonia amount N1, and the detected intake air amount G1, the detected rich air-fuel ratio R2, the detected ammonia amount N2, and the detected intake air amount G1, the detected rich air-fuel ratio R3, the detected ammonia amount N3, and the detected intake air amount G1, and estimate the degree of degradation based on the regression line.

By estimating the degree of degradation of the downstream catalyst 32 based on the data acquired a plurality of times as described above, the estimation accuracy of the degree of degradation is improved. Further, the estimation accuracy of the degradation degree is also improved by switching the determination value to a different value. This is because, by switching the determination value to a different value, at least a plurality of detected rich air-fuel ratios having different values and a plurality of detected ammonia amounts having different values are acquired.

Also in the present modification, the detection-rich air-fuel ratio R1 to R3 is the smallest value of the detected air-fuel ratio from when the detected air-fuel ratio becomes equal to or lower than the determination value D1 to D3 to when the detected air-fuel ratio reaches the stoichiometric air-fuel ratio. The detected ammonia amount N1 to N3 is the largest value of the ammonia amount between the detected air-fuel ratio becomes equal to or lower than the determination value D1 to D3 and the stoichiometric air-fuel ratio. Therefore, the estimation accuracy of the degradation degree is improved.

In the above example, the number of times of data acquisition is three, but may be two or four or more. In consideration of the estimation accuracy of the degradation degree, the number of times of data acquisition is preferably three or more. When the intake air amount changes during the execution of the rich active process, a plurality of detected intake air amounts having different values corresponding to the plurality of acquired detected rich air-fuel ratios are acquired.

When the temperature of the downstream catalyst 32 becomes higher than the predetermined temperature, a rich-lean active process for estimating the degree of degradation of the upstream catalyst 31 is executed (time t13). When the rich-lean active process is executed, the target air-fuel ratio is set to the rich air-fuel ratio, and the upstream catalyst 31 is in the oxygen-depleted state, so that the detected air-fuel ratio is lowered. When the detected air-fuel ratio becomes equal to or lower than the determination value RD indicating the rich air-fuel ratio, the target air-fuel ratio is switched to the lean air-fuel ratio, and the detected air-fuel ratio increases, but the ammonia quantity discharged from the upstream catalyst 31 temporarily increases. When the upstream catalyst 31 is oxygen-saturated and the detected air-fuel ratio is equal to or higher than the determination value LD indicating the lean air-fuel ratio, the target air-fuel ratio is switched to the rich air-fuel ratio, and the detected air-fuel ratio is lowered, but the discharge of NOx from the upstream catalyst 31 is temporarily increased. As described above, when the detected air-fuel ratio becomes equal to or lower than the stoichiometric air-fuel ratio with the target air-fuel ratio set to the rich air-fuel ratio after the detected air-fuel ratio reciprocates between the determination value RD and the determination value LD a plurality of times, the rich-lean active process ends (time t14). Note that FIG. 6 exemplifies a case where the detected intake air amount G2 is constant during the rich-lean active process. ECU 50 calculates the maximum oxygen storage amount of the upstream catalyst 31 based on the detected intake air amount G2 from the time when the target air-fuel ratio is switched from the rich air-fuel ratio to the lean air-fuel ratio until the time when the target air-fuel ratio is switched from the lean air-fuel ratio to the rich air-fuel ratio. ECU 50 estimates the degree of degradation of the upstream catalyst 31 based on the largest oxygen-storage capacity.

As described above, when the temperature of the downstream catalyst 32 is higher than the predetermined temperature, the degree of degradation of the upstream catalyst 31 is estimated. Here, since the upstream catalyst 31 is closer to the engine body 2 than the downstream catalyst 32, it is considered that the upstream catalyst 31 is higher in temperature than the downstream catalyst 32. Therefore, when the temperature of the downstream catalyst 32 is higher than the predetermined temperature, it is considered that the temperature of the upstream catalyst 31 is equal to or higher than the activation temperature of the upstream catalyst 31. When the temperature of the upstream catalyst 31 is equal to or higher than the activation temperature, the maximum oxygen storage amount of the upstream catalyst 31 is accurately calculated. Therefore, the degree of degradation of the upstream catalyst 31 is improved in estimation accuracy. As described above, the estimation accuracy of the degradation degree of the downstream catalyst 32 is improved when the temperature of the downstream catalyst 32 is equal to or lower than the predetermined temperature, and the estimation accuracy of the degradation degree of the upstream catalyst 31 is improved when the temperature of the downstream catalyst 32 is higher than the predetermined temperature.

Although the preferred embodiment of the disclosure is described above in detail, the disclosure is not limited to the specific embodiment, and various modifications and changes may be made within the scope of the disclosure described in claims.

What is claimed is:

1. A degradation degree estimation system comprising:
an airflow meter that detects an intake air amount of an engine;
a three-way catalyst disposed in an exhaust passage of the engine and able to store oxygen;
an air-fuel ratio sensor disposed in the exhaust passage upstream of the three-way catalyst;
an NOx sensor disposed in the exhaust passage downstream of the three-way catalyst and able to detect an amount of ammonia in an exhaust gas; and
an estimation device that estimates a degree of degradation of the three-way catalyst, wherein the estimation device includes
an acquisition unit that acquires a detected rich air-fuel ratio that is a detected air-fuel ratio detected by the air-fuel ratio sensor when the detected air-fuel ratio indicates a rich air-fuel ratio, a detected intake air amount detected by the airflow meter, and a detected ammonia amount detected by the NOx sensor, and
an estimation unit that estimates the degree of degradation based on the detected rich air-fuel ratio, the detected intake air amount, and the detected ammonia amount, the estimation unit estimating a higher degree of degradation as the detected ammonia amount is smaller with respect to the detected rich air-fuel ratio and the detected intake air amount.

2. The degradation degree estimation system according to claim 1, wherein:
the acquisition unit acquires at least three detected rich air-fuel ratios having different values, and the detected intake air amount and the detected ammonia amount corresponding to each of the at least three detected rich air-fuel ratios; and
the estimation unit estimates the degree of degradation based on the at least three detected rich air-fuel ratios and the detected intake air amount and the detected ammonia amount corresponding to the each of the at least three detected rich air-fuel ratios.

3. The degradation degree estimation system according to claim 2, wherein:
an upstream catalyst able to store oxygen and a downstream catalyst located downstream of the upstream catalyst are disposed in the exhaust passage;
the three-way catalyst is the downstream catalyst;
the air-fuel ratio sensor is disposed between the upstream catalyst and the downstream catalyst; and
the estimation device includes
a control unit that executes a rich active process of reciprocating the detected air-fuel ratio at least three times between a stoichiometric air-fuel ratio and a rich air-fuel ratio by switching a target air-fuel ratio of the engine from a rich air-fuel ratio to a lean air-fuel ratio when the detected air-fuel ratio becomes equal to or less than a determination value indicating a rich air-fuel ratio, and switching the target air-fuel ratio from a lean air-fuel ratio to a rich air-fuel ratio when the detected air-fuel ratio becomes equal to or more than the stoichiometric air-fuel ratio, and
a switching unit that switches the determination value to a different value when the detected air-fuel ratio becomes equal to or less than the determination value during execution of the rich active process.

4. The degradation degree estimation system according to claim 3, wherein the acquisition unit acquires, as the detected rich air-fuel ratio, a minimum value of the detected air-fuel ratio during a period since the detected air-fuel ratio becomes equal to or less than the determination value until the detected air-fuel ratio becomes equal to or more than the stoichiometric air-fuel ratio, and acquires, as the detected ammonia amount, a maximum value of the ammonia amount during the period since the detected air-fuel ratio becomes equal to or less than the determination value until the detected air-fuel ratio becomes equal to or more than the stoichiometric air-fuel ratio.

5. The degradation degree estimation system according to claim 4, wherein:
the estimation device includes an upstream catalyst estimation unit that estimates a degree of degradation of the upstream catalyst based on a maximum oxygen storage amount of the upstream catalyst;
the upstream catalyst estimation unit estimates the degree of degradation of the upstream catalyst when a temperature of the downstream catalyst is higher than a predetermined temperature; and
the estimation unit estimates a degree of degradation of the downstream catalyst when the temperature of the downstream catalyst is equal to or lower than the predetermined temperature.
